(19) United States
(12) Patent Application Publication
(10) Pub. No.: US 2003/0005422 A1
(43) Pub. Date: Jan. 2, 2003

(54) Technique for improving the prediction rate of dynamically unpredictable branches

(76) Inventors: Nicolai Kosche, San Francisco, CA (US); Chris Hescott, Minneapolis, MN (US); Qing Zhao, Urbans, IL (US); Youngsoo Choi, Pleasanton, CA (US); David J. Lilja, Maplewood, MN (US)

Correspondence Address: ROSENTHAL & OSHA L.L.P., 1221 MCKINNEY AVENUE, SUITE 2800, HOUSTON, TX, 77010, US

(21) Appl. No.: 09/897,843

(22) Filed: Jul. 2, 2001

(51) Int. Cl. G06F 9/45

(52) U.S. Cl. 717/154

(57) ABSTRACT

A method of improving a prediction rate for instructions in code includes determining a sequence from profile information; and transforming the code based on the determined sequence. A method of improving processor performance includes transforming a set of branches into a second set of branches, wherein the second set of branches comprises the original set of branches; and a sequence of branches likely to execute as an entity. A processor includes means for processing instructions; and means for transforming a set of branches into a second set of branches, wherein the second set of branches comprises the original set of branches; and a sequence of branches likely to execute as an entity.

### BACKGROUND OF INVENTION

Computer processors contain arithmetic, logic, and control circuitry that interpret and execute instructions from a computer program. Referring to FIG. 1, a typical computer system includes a microprocessor (10) having, among other things, a CPU (12) containing a load/store unit (14), and an on-board cache memory (16). The microprocessor (12) is connected to external cache memory (17) and a main memory (18) that both hold data and program instructions to be executed by the microprocessor (10). Internally, the execution of program instructions is carried out by the CPU (12). Data needed by the CPU (12) to carry out an instruction are fetched by the load/store unit (14) and loaded into internal registers (15) of the CPU (12). Upon command from the CPU (12), the load/store unit (14) searches for the data first in the fast on-board cache memory (16), then in external cache memory (17), and finally in the main memory (18). Finding the data in the cache memory is referred to as a “hit.” Not finding the data in the cache memory is referred to as a “miss.”

The time between when a CPU requests data and when the data is retrieved and available for use by the CPU is termed the “latency” of the request. If requested data is found in cache memory, i.e., a data hit occurs, the requested data can be accessed at the speed of the cache and the latency of the system is reduced. If, on the other hand, the data is not found in cache, i.e., a data miss occurs, and thus the data must be retrieved from main memory for access and the latency of the request is increased.

In the pursuit of improving processor performance, designers have sought two main goals: making operations faster and executing more operations in parallel. Making operations faster can be approached in several ways. For example, transistors can be made to switch faster and thus propagate signals faster by improving semiconductor processes; execution-unit latency can be reduced by increasing the number of transistors in the design; and the levels of logic required by the design to implement a given function can be minimized to increase speed. To execute more operations in parallel, designers mainly rely on one, or a combination of pipelining and superscalar techniques. Pipelined processors overlap instructions in time on common execution resources. Superscalar processors overlap instructions in space on separate resources.

Pipeline stalls are a main performance inhibitor with regard to parallel processing. Stalls arise from data dependencies, changes in program flow, and hardware resource conflicts. At times, pipeline stalls can be avoided by rearranging the order of execution for a set of instructions. Compilers can be used to statically reschedule instructions. However, incomplete knowledge of run-time information reduces the effectiveness of static rescheduling. In-order processors, i.e., processors that issue, execute, complete, and retire instructions in strict program order, have to rely entirely on static rescheduling and thus are prone to pipeline stalls.

As a result, designers generally use out-of-order processors and seek to implement dynamic instruction rescheduling. The simplest out-of-order processors issue instructions in order but allow them to execute out of order. Even these simple out-of-order processors require complex hardware to reorder results before the corresponding instructions are retired. A strict result order is not required from a data-flow perspective. However, such ordering is necessary to maintain precise exceptions and to recover from mispredicted speculative execution.

A well-known method of reordering is through the use of a reorder buffer, i.e., a buffer that maintains results until written to the register file in program order. Designers also use other types of reordering hardware, such as history buffers and future files. History buffers record source-operand history so the processor can backtrack to a precise architectural state and future files store the current state and the architectural state in separate register files allowing the processor to be restored to a precise check-point state.

Branch prediction and speculative execution are additional techniques used to increase the efficiency of a processor. In a pipelined processor, the outcomes of branch instructions are often determined after subsequent instructions have been fetched. Using branch prediction schemes, microprocessors attempt to accurately predict whether a branch is taken or not based on how that branch has behaved previously. The aggregate behavior, or the average behavior over time, of the branch instruction is stored in a Branch Prediction Table (“BPT”). Given a branch instruction's aggregate behavior, the branch predictor, which resides in an instruction fetch unit, predicts the outcome of the branch instruction and then loads instructions thereafter based on that prediction. For example, if the branch predictor predicts that a branch will be taken, then the processor fetches subsequent instructions according to the address to which the instruction branches. When the branch proceeds in the predicted direction, pipeline stalls are completely avoided. On the other hand, if the branch direction is mispredicted, all the instructions after the mispredicted instruction must be removed from the processor.

Among other techniques, compiler technology, e.g., trace scheduling, profiling, and case-peeling, is used to improve the accuracy of these predictions. Trace scheduling is a compiler technique that schedules across several branches. Trace scheduling relates to the arrangement of a control flow from the most frequently executed paths, possibly at the expense of the less frequently executed paths. Profiling is a compiler technique that involves monitoring of the execution of code to identify a history pattern. The generated profile information can then be used by a dynamic branch predictor in situations where history information upon which to base prediction is not available. Case-peeling is the removal of one case from the beginning of a switch by inserting a copy of the entire case statement before the beginning of the switch.

Certain loops have multi-way branches that are impossible to predict in hardware. Specifically, many interpretive engines have a multi-way branch for each interpreted instruction. Because these instructions vary, prediction hardware routinely has a low probability of computing the target. Referring to FIG. 2, a exemplary block diagram showing a conventional branched instruction line (100) with identified line probabilities. In the example shown, a switch instruction (102) leads to a next instruction (110) through one of three possible cases, case 1 (104), case 2, (106), and case 3 (108). From profiling, it is known that case 1 has an associated probability of 35% (P=0.35), case 2 has an associated probability of 33% (P=0.33), and case 3 has an associated probability of 32% (P=0.32). Thus, in the prediction of the flow, the compiler proceeds from the highest probability case to the lowest probability case as illustrated in FIG. 3.

FIG. 3 shows exemplary conventional code (112) for processing a branched instruction line. Because case 1 has the highest probability, case 1 is predicted first. As can be seen, the associated probability of prediction is 65% (P=0.65) that the branch will not be taken. In the situation that case 1 is not taken, case 2 is predicted as it has the second highest probability. After the occurrence of case 1, the probability for case 2 occurring is 51% (P=0.51). Lastly, the case 3 is predicted. After eliminating case 1 and case 2, case 3 has an associated probability of 100% (P=1.00). This prediction process is repeated on every loop.

### SUMMARY OF INVENTION

In general, in one aspect, the present invention involves a method for improving branch prediction rates in a microprocessor comprising processing a case; determining a next case from a sequence involving the processed case; and processing the next case.

In general, in one aspect, the present invention involves a method of improving a prediction rate for instructions in code comprising determining a sequence from profile information; and transforming the code based on the determined sequence.

In general, in one aspect, the present invention involves an apparatus for improving branch prediction rates in a microprocessor comprising a compiler comprising an optimization component, wherein the optimization component determines a sequence from profile information and transforms code received by the compiler based on the determined sequence.

In general, in one aspect, the present invention involves a software tool for improving branch prediction rates in a microprocessor comprising a program stored on computer-readable media for processing a case; determining a next case from a sequence involving the processed case; and processing the next case.

In general, in one aspect, the present invention involves a software tool for improving a prediction rate for instructions in code comprising a program stored on computer-readable media for determining a sequence from profile information; and transforming the code based on the determined sequence.

In general, in one aspect, the present invention involves an apparatus for improving branch prediction rates in a microprocessor comprising means for determining a sequence; and means for transforming code based on the sequence.

In general, in one aspect, the present invention involves a method of improving branch prediction rates in a microprocessor comprising converting a plurality of unpredictable branches into a set of predictable branches by expanding at least one of the unpredictable branches into a follow-set branch based on a profile for the unpredictable branches.

In general, in one aspect, the present invention involves a method for improving branch prediction rates in a microprocessor comprising determining a sequence involving a branch from profile information; processing the branch; determining a next branch in the sequence; and selectively processing the next branch during the processing of the branch based on an associated probability.

In general, in one aspect, the present invention involves a method of improving processor performance comprising transforming a set of branches into a second set of branches, wherein the second set of branches comprises the original set of branches; and a sequence of branches likely to execute as an entity.

In general, in one aspect, the present invention involves a processor comprising means for processing instructions; and means for transforming a set of branches into a second set of branches, wherein the second set of branches comprises the original set of branches; and a sequence of branches likely to execute as an entity.

Other aspects and advantages of the invention will be apparent from the following description and the appended claims.

### BRIEF DESCRIPTION OF DRAWINGS

FIG. 1 shows a typical computer system.

FIG. 2 shows an exemplary conventional branched instruction line with identified line probabilities.

FIG. 3 shows exemplary conventional code for processing a branched instruction line.

FIG. 4 shows an exemplary branched instruction line with identified line probabilities in accordance with an embodiment of the present invention.

FIG. 5 shows exemplary code for processing a branched instruction line in accordance with an embodiment of the present invention.

FIG. 6 is a flow chart describing branched instruction line processing in accordance with an embodiment of the present invention.

FIG. 7 is a flow chart describing branched instruction line processing in accordance with an embodiment of the present invention.

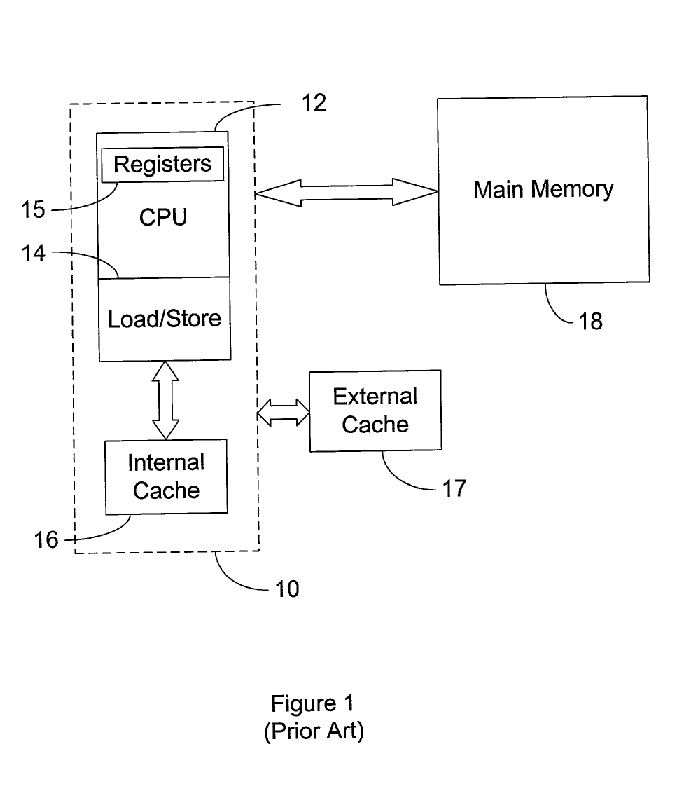

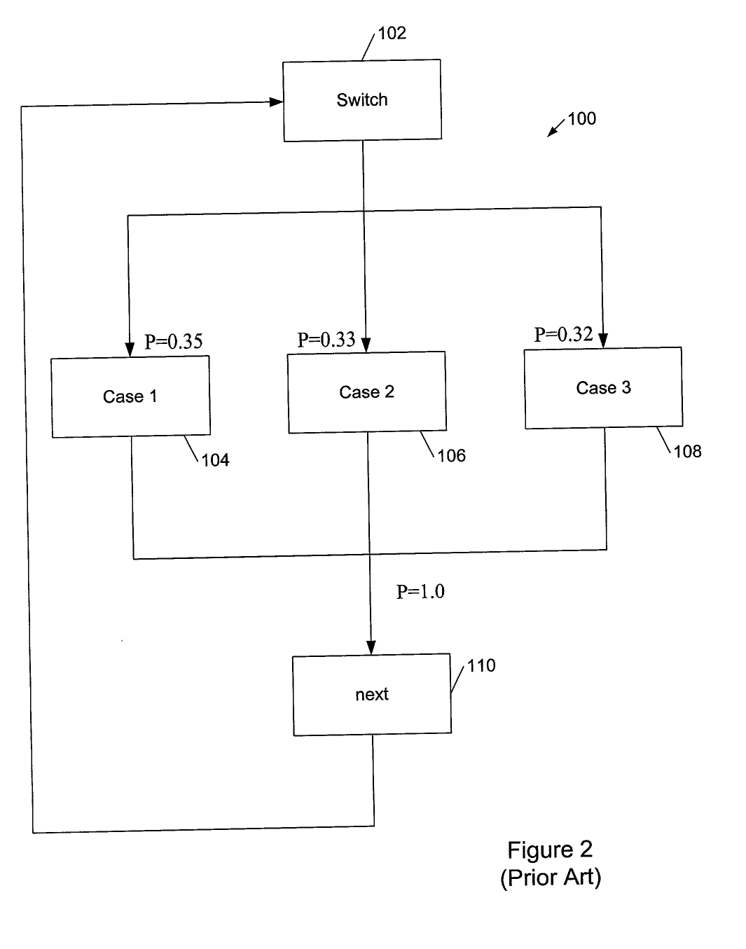

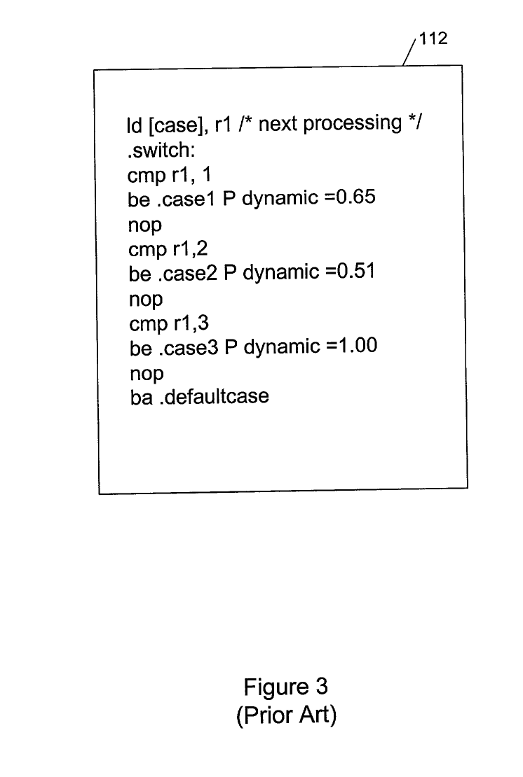

### DETAILED DESCRIPTION

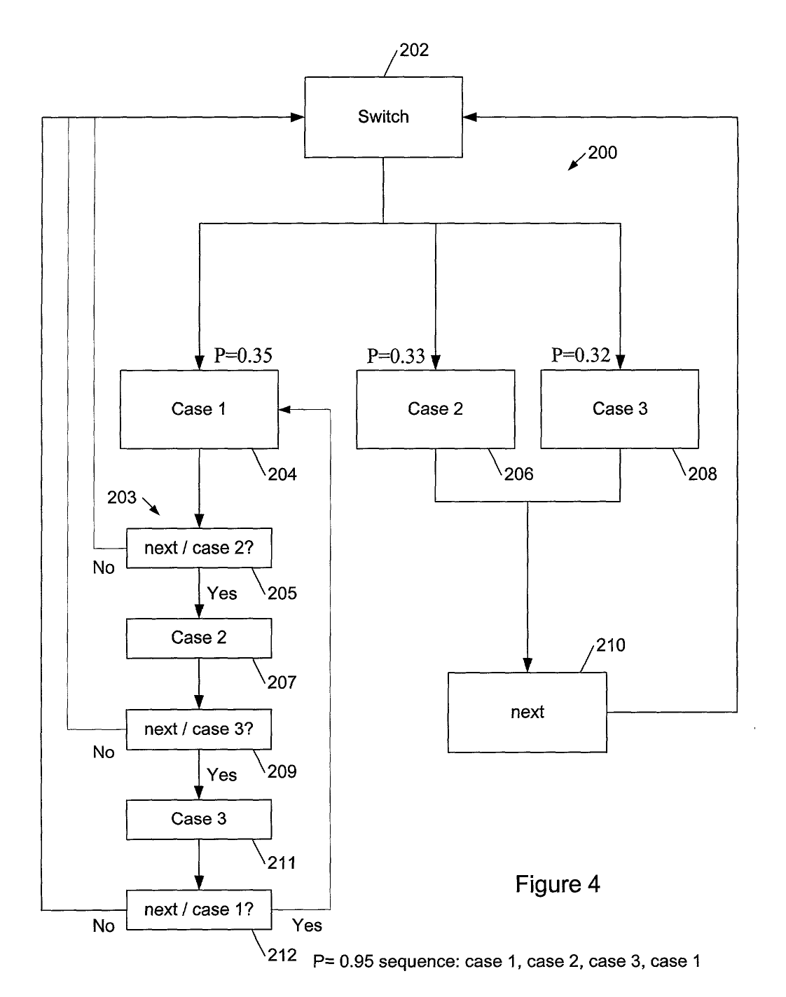

The present invention relates to a method and apparatus for improving the prediction rate of dynamically unpredictable branches. In one or more embodiments, the present invention improves the predictability of branches through the use of follow-sets, or likely branch target sequences. The follow-sets are used to isolate cases where branch sequences are predictable. Referring to the drawings, FIG. 4 shows an exemplary branched instruction line with identified line probabilities in accordance with an embodiment of the present invention.

In the example shown, a switch instruction (202) leads to a next instruction (210) via one of three cases: case 1 (204); case 2 (206); and case 3 (208). Additionally, a follow-set (203) is created after the most probable case, case 1 (204). The follow-set includes three new instructions (205), (209), and (212), together with the “next” cases in sequence, case 2 (207) and case 3 (211). The “next” cases in sequence, case 2 (207) and case 3 (211) are copies of case 2 (206) and case 3 (208) respectively. The new instructions (205), (209), and (212) determine whether the sequence continues in accordance with profile information for the flow. In this example there is a 95% probability that the sequence case 1, case 2, case 3, case 1 will occur (P=0.95 sequence case 1, case 2, case 3, case 1).

The follow-set involves grouping sequences of likely cases together so that the sequences have more branches, but the branches are more predictable. In the example shown, when case 1 (204) occurs, given the profile information, it is highly likely that case 2 (207) will occur next. Thus, that probability is exploited to a create better prediction scheme. Similarly, when case 2 (207) occurs, it is highly likely that case 3 (211) will occur next and when case 3 (211) occurs that case 1 (204) will occur next. By duplicating the “next” computation and creating a test for the subsequent case condition as a subset of the switch/multiway branch, a sequence of instructions with predictable branches is. created.

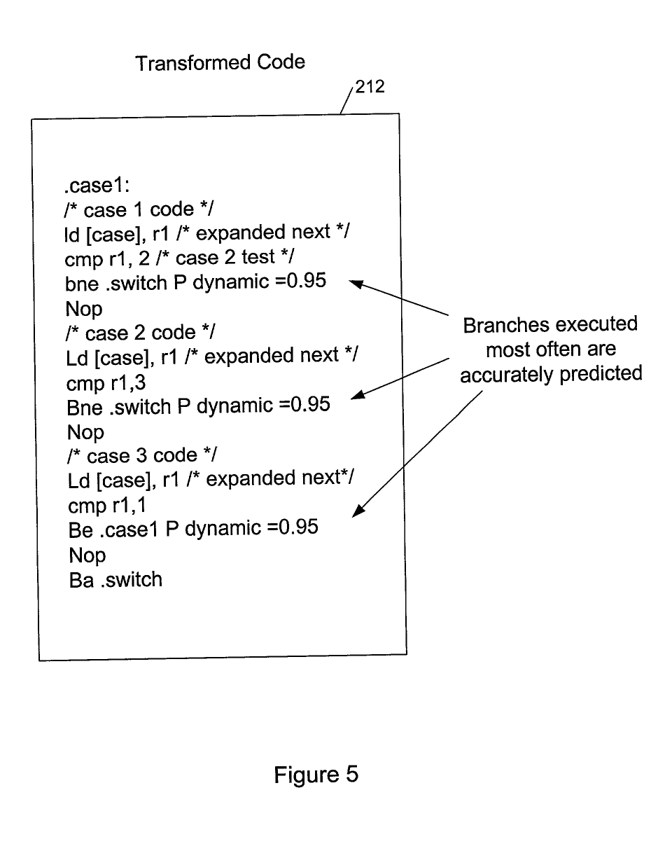

Referring to FIG. 5, exemplary code for processing a branched instruction line in accordance with an embodiment of the present invention is shown. The code shown adds a follow-set to the standard code for processing case 1 (204). As can be seen, the probability of accurately predicting case 2 (206) after case 1 (204) occurs is 95% (P=0.95). Further, the sequence continues accordingly with 95% probabilities for case 2 (206) to case 3 (208) and case 3 (208) back to case 1 (204). Thus, the branches executed most often are accurately predicted.

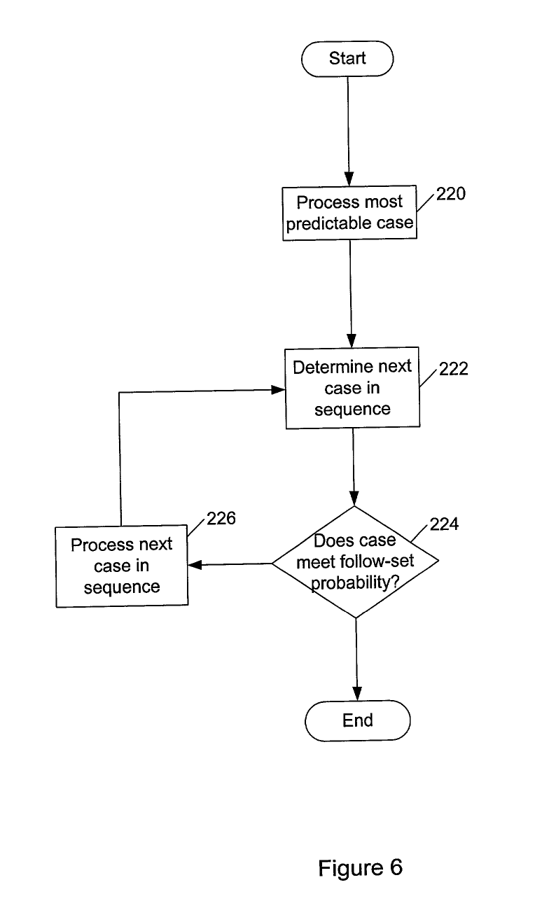

A process in accordance with one or more embodiments of the present invention is shown in FIG. 6. First, the most predictable case in the set is processed (step 220). Then, the most probable next case is determined from sequence information (step 222). If the determined next case meets the follow-set probability threshold (step 224), that next case is processed (step 226). If not, the process ends. Thus, once the first case in the sequence has been processed, the remaining stages of the sequence are checked prior to restarting case prediction. In this manner, the probability of accurate prediction is increased. Those skilled in the art will appreciate that this process is not limited to sequences beginning with the most probable case, rather it can be applied to all known sequences.

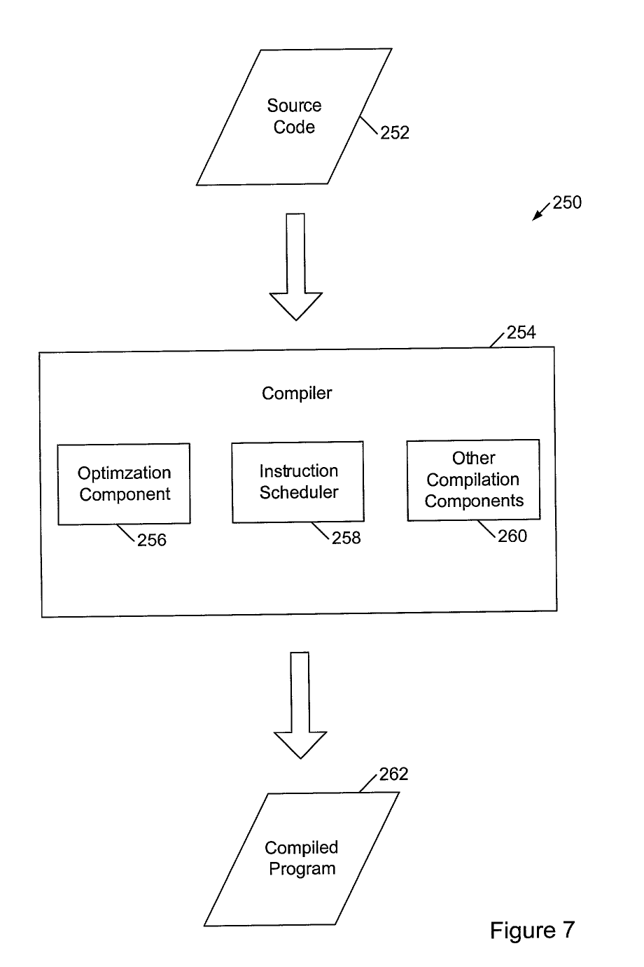

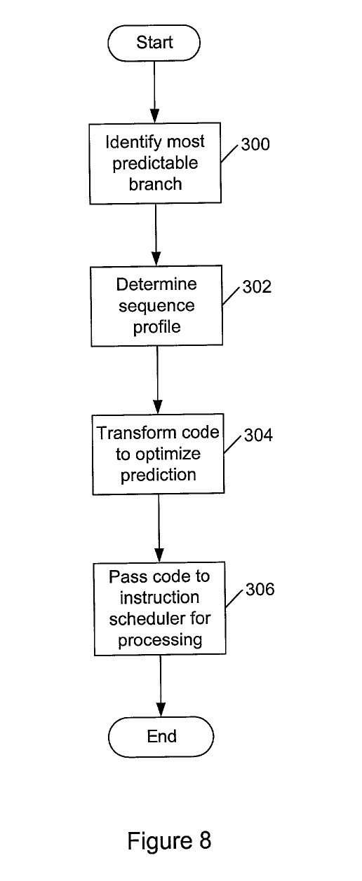

Referring to FIG. 7, the compilation process (250) involves translating source code (252) with a compiler (254) to produce a compiled program (262) suitable for execution on a processor. The compiler (254) includes an optimization component (256) in accordance with one or more embodiments of the present invention, as well as an instruction scheduler (258), and other compilation components (260) for carrying out other compilation tasks. During compilation, the source code (252) is converted into intermediary stages by the components of the compiler (254). Specifically, the optimization component (256) transforms the code by adding a follow-set as described above for sequences identified from profile information. The operation of the optimization component (256) is discussed in more detail below. Once an independent portion of the source code (252) has been optimized by the optimization component (256), the instruction scheduler (258) compiles an instruction set. The operation of the instruction scheduler and other compiler components are well known in the art and will not be discussed in detail here.

FIG. 8 is a flow chart describing exemplary operation of the optimization component (256) in accordance with one or more embodiments of the present invention. The process begins with the identification of the most predictable branch (step 300) and reliable sequences from profile information (step 302). Then, the code is transformed into a follow-set structure as described above (step 304). Finally, after optimizing the code, the optimization component (256) passes the code to the instruction scheduler (258) for further processing (step 306). Those skilled in the art will appreciate that the order of identification may vary or occur concurrently, and the transformation process may occur multiple times for different sequences before passing the code to the instruction scheduler (258).

Advantages of the present invention may include one or more of the following. Sequences of likely cases are grouped together so that the sequences have more branches, but the branches are more predictable. These sequences of more predictable branches yield more efficient processor operations because memory transactions requested by the processor are more probably going to be used by the processor. Accordingly, less unnecessary memory transaction are requested by the processor. Also, branches can be grouped into larger sets. This allows longer traces to be created with greater certainty. These traces can be further optimized via trace scheduling techniques, and other techniques. Thus, the probability of accurately predicting branches is increased and hardware branch prediction is improved. Those skilled in the art will appreciate that the present invention also may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for improving branch prediction rates in a microprocessor comprising:
processing a case;
determining a next case from a sequence involving the processed case; and
processing the next case.

2. The method of claim 1, further comprising:
selectively processing the next case based on an associated probability.

3. The method of claim 1, wherein determining the next case and processing the next case occur during the processing of the case.

4. The method of claim 1, further comprising:
determining the sequence from profile information.

5. The method of claim 1, further comprising:
determining a second next case from the sequence; and
processing the second next case.

6. The method of claim 5, wherein processing the second next case is selective based on an associated probability.

7. The method of claim 5, wherein determining the second next case and processing the second next case occur during the processing of the case.

8. The method of claim 1, wherein the case and the next case are branch instructions.

9. A method of improving a prediction rate for instructions in code comprising:
determining a sequence from profile information; and
transforming the code based on the determined sequence.

10. The method of claim 9 wherein transforming the code comprises:
adding a follow-set to a portion of the code for processing a first instruction in the sequence.

11. The method of claim 10, wherein adding the follow-set is selective based on a probability associated with the sequence.

12. An apparatus for improving branch prediction rates in a microprocessor comprising:
a compiler comprising an optimization component,
wherein the optimization component determines a sequence from profile information and transforms code received by the compiler based on the determined sequence.

13. The apparatus of claim 12, wherein the optimization component adds a follow-set to a portion of the code.

14. A software tool for improving branch prediction rates in a microprocessor comprising:
a program stored on computer-readable media for processing a case;
determining a next case from a sequence involving the processed case; and
processing the next case.

15. The software tool of claim 14, further comprising:
a program stored on computer-readable media for selectively processing the next case based on an associated probability.

16. The software tool of claim 15, wherein determining the next case and processing the next case occur during the processing of the case.

17. The software tool of claim 16, further comprising:
a program stored on computer-readable media for determining the sequence from profile information.

18. The software tool of claim 14, further comprising:
a program stored on computer-readable media for determining a second next case from the sequence; and
processing the second next case.

19. The software tool of claim 18, further comprising:
a program stored on computer-readable media for selectively processing the second next case based on an associated probability.

20. The software tool of claim 18, wherein determining the second next case and processing the second next case occur during the processing of the case.

21. The software tool of claim 14, wherein the case and the next case are branch instructions.

22. A software tool for improving a prediction rate for instructions in code comprising:
a program stored on computer-readable media for determining a sequence from profile information; and
transforming the code based on the determined sequence.

23. The software tool of claim 22, wherein transforming the code comprises:
a program stored on computer-readable media for adding a follow-set to a portion of the code for processing a first instruction in the sequence.

24. The software tool of claim 22, wherein adding the follow-set is selective based on a probability associated with the sequence.

25. An apparatus for improving branch prediction rates in a microprocessor comprising:
means for determining a sequence; and
means for transforming code based on the sequence.

26. The apparatus of claim 25, further comprising:
means for adding a follow-set to a portion of the code.

27. A method of improving branch prediction rates in a microprocessor comprising:
converting a plurality of unpredictable branches into a set of predictable branches by expanding at least one of the unpredictable branches into a follow-set branch based on a profile for the unpredictable branches.

28. A method for improving branch prediction rates in a microprocessor comprising:
determining a sequence involving a branch from profile information;
processing the branch;
determining a next branch in the sequence; and
selectively processing the next branch during the processing of the branch based on an associated probability.

29. The method of claim 28, further comprising:
determining second next branch in the sequence; and
selectively processing the second next branch during the processing of the branch based on an associated probability.

30. The method of claim 28, wherein the processing is based on code transformed to comprise a follow-set for the sequence.

31. A method of improving processor performance comprising:
transforming a set of branches into a second set of branches,
wherein the second set of branches comprises
the original set of branches; and
a sequence of branches likely to execute as an entity.

32. A processor comprising:
means for processing instructions; and
means for transforming a set of branches into a second set of branches,
wherein the second set of branches comprises
the original set of branches; and
a sequence of branches likely to execute as an entity.
